(19) United States
(12) Patent Application Publication
(10) Pub. No.: US 2024/0331104 A1
(43) Pub. Date: Oct. 3, 2024

(54) Mult-Channel Color Space Dehazing Network

(71) Applicant: Sukhmeet Singh, Riverside, CA (US)

(72) Inventor: Sukhmeet Singh, Riverside, CA (US)

(21) Appl. No.: 18/598,980

(22) Filed: Mar. 7, 2024

Related U.S. Application Data
(60) Provisional application No. 63/450,810, filed on Mar. 8, 2023.

(51) Int. Cl. G06T 5/60; G06T 5/50; G06T 5/73; G06T 5/92; G06T 11/00; G06V 10/56; G06V 10/82; G06V 20/52

(52) U.S. Cl. CPC G06T 5/60; G06T 5/50; G06T 5/73; G06T 5/92; G06T 11/001; G06V 10/56; G06V 10/82; G06V 20/52; G06T 2207/10016; G06T 2207/10024; G06T 2207/20084; G06T 2207/20212; G06T 2210/52

(57) ABSTRACT

Systems and methods are disclosed for image enhancement and de-hazing video. Various embodiments comprise a convolutional neural network having a U-net architecture with pairs of encoder and decoder convolutional blocks. In one or more embodiments the CNN is configured with a layer-to-layer skip-connection between layers of each pair of convolutional blocks to transfer a feature map from an encoder portion to a decoder portion. Various embodiments further comprise a processor and program instructions executable by the processor to cause the processor to receive an input image and generate one or more data sets of images corresponding to channels that define one or more color spaces. Various embodiments comprise processing each of the images into a plurality of processed outputs corresponding to color space channels and generating a dehazed image by convoluting a concatenation of the plurality of processed outputs.

### FIELD OF THE DISCLOSURE

The present disclosure relates to encoder-decoder-based image enhancement, and more specifically, to encoder-decoder-based image dehazing.

### BACKGROUND

Image dehazing is a computational image processing technique that aims to remove the visual degradation caused by the presence of haze or fog in images. Haze is a natural atmospheric phenomenon caused by the scattering of light by small particles in the air, such as dust or water droplets. When light enters a hazy environment, it scatters in all directions, reducing the contrast and color saturation of the scene and leading to a loss of visual detail and sharpness. Thus, the goal of image dehazing is to improve the visual quality of a hazy image by removing the visual degradation using various mathematical dehazing methods.

Several methods have been proposed for implementing image dehazing. For example, some methods have included a correction technique using a correlation between the high frequency and the low-frequency color bands. Such methods quantify the amount of haze using different spectral bands in the visible region. Other methods utilize a virtual cloud point method based on relative haze thickness for haze removal. Some methods suggested a gradient-based spectral adaptive approach to exploit the wavelength-dependent transmission information. Other methods utilize a hyperspectral image (HSI) in combination with a multi-channel image. Dehazing methods can be generally grouped into two categories, including multi-image and single image methods. In general, multi-image methods remove haze by utilizing complementary information from temporal or spectral images. By contrast, single image methods maximize the information from a single hazy image to remove haze.

Image dehazing has important applications in various fields, such as computer vision, remote sensing, and automotive safety, where the visibility of images captured in hazy environments is important for accurate analysis and decision-making. It is also an active area of research in computer vision and image processing, with ongoing efforts to improve the accuracy and efficiency of dehazing algorithms for real-world applications.

### SUMMARY

Embodiments of the disclosure are directed to an encoder-decoder-based image enhancement system and method for reducing the visual effect of haze in video frames or other images. In such embodiments, an end-to-end machine-learning system and algorithm is disclosed. In one or more embodiments are directed to a multi-channel multi-color space strategy that allows a user to extract distinct and useful features pertinent to haze that are associated with individual channels in various color spaces. In such embodiments, this multi-channel, multi-color space approach allows for relevant dehazing algorithms to learn patterns of haze more effectively and to reduce their effect on the video frames by providing a greater number of features for training.

In one or more embodiments, the image enhancement system comprises a convolutional neural network (CNN) having an encoder portion and a decoder portion and having a U-net architecture with a plurality of levels. In one or more embodiments the encoder portion and decoder portion include convolutional blocks at each level of the U-net architecture. For example, in certain embodiments the encoder portion includes an encoder convolutional block, and the decoder portion includes a decoder convolutional block. In certain embodiments, the convolutional blocks are paired, meaning that the convolutional blocks in the encoder portion and decoder portion share the same level in the U-net architecture. In various embodiments each of the convolutional blocks comprises one or more corresponding layers In one or more embodiments the CNN is configured with a plurality of skip-connections between paired convolutional blocks. In various embodiments the skip-connections are configured to transfer a feature map from the encoder portion to the decoder portion by connecting the convolutional blocks. In one or more embodiments the skip-connections are configured as layer-to-layer skip-connection, where at paired convolutional blocks one layer of a convolutional block at the encoder portion is connected to one a layer of a convolutional block at the decoder portion. In certain embodiments the layer-to-layer skip-connection includes a plurality of skip-connections between each layer of each pair of convolutional blocks. In such embodiments the CNN is configured to allow for transfers of a feature map from the encoder portion to the decoder portion at the individual layer level, rather than from a block-to-block level.

In one or more embodiments, the image enhancement system further comprises a processor and a computer readable storage medium having program instructions embodied within. In one or more embodiments, the program instructions are executable by the processor to cause the processor to perform methods and functions of embodiments of the disclosure. For example, in various embodiments the processor is configured to receive an input image and generate a first data set by converting the input image into a first plurality of images corresponding to a first plurality of color channels that define a first color space. In one or more embodiments, the processor is configured to generate a second data set by converting the input image into a second plurality of images corresponding to a second plurality of color channels that define a second color space.

In various embodiments, the processor is further configured to transmit the first and second data sets to the CNN such that the encoder portion of the CNN receives and processes each of the first and second plurality of images corresponding to the channels of the first and second color space. In one or more embodiments, the CNN outputs through the decoder portion a processed data set comprising a plurality of processed outputs corresponding to channels defining the first color space and the second color space. And, in various embodiments, the program instructions are executable to cause the processor to generate a dehazed image by convoluting a concatenation of the plurality of processed outputs of the processed data set.

In one or more embodiments the image enhancement system is configured for de-hazing video or video frames. In such embodiments, the system can include a video capturing device for capturing a video of a scene comprising a series of input frames. In one or more embodiments the system is configured to receive the video from the video capturing device and split the input frames from the video into a plurality of individual images. In various embodiments the input image is one of the individual images from the video. In one or more embodiments the system is further configured to process one or more of the individual images to produce a plurality of dehazed image frames and to generate a dehazed video by combining two or more dehazed image frames.

The Applicants have observed that in encoder-decoder based dehazing methods the characteristics of haze are presented differently in different color spaces. Thus, the Applicants have discovered that, by processing images based on different channels in one or more color spaces, features that would not normally be seen can be extracted and learned by the proposed deep neural networks. An algorithm that is trained on these additional features is capable of more effectively dehazing input video frames and obtaining better visibility than alternative methods. As such, various embodiments of the disclosure are configured to assign an encoder and a decoder on each channel in one or more color spaces. In such embodiments the encoder is responsible for extracting useful features of haze, where the decoder is configured to restore spatial information of the input image with good quality and with reduced haze. Further, various embodiments provide a system that does not require feature engineering or additional pre-processing of input video frames or images.

In one or more embodiments, the image enhancement system is configured as an element in a camera-based fire detection and/or visual recognition system. In such embodiments the camera-based fire detection system is generally configured to generate an alarm output upon visual identification of heavy smoke or flame in a monitored space. In various embodiments the image enhancement system can be configured as a first stage of the fire detection system. In such embodiments the system will first search for upcoming video frames. Once a video is found, the image enhancement system is configured to input video frames and split them into individual frames, and then send each video frame to the multi-channel multi-color space network to perform initial dehazing. In the last stage, the output (dehazed video frames) from the network will be sent to downstream tasks, such as fire detection, smoke detection, and the like. In such embodiments the image enhancement system is a useful addition with new or existing fire monitoring and smoke detection systems. For example, in various embodiments the image enhancement system can be utilized to reduce degradation from fog, haze, or other suspended particles generated during combustion or from the weather.

The above summary is not intended to describe each illustrated embodiment or every implementation of the present disclosure.

### BRIEF DESCRIPTION OF THE SEVERAL VIEWS OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a high-level view of an image enhancement system for de-hazing, according to one or more embodiments of the disclosure.

FIG. 2 depicts a convolutional neural network diagram having a U-net architecture for dehazing images, according to one or more embodiments of the disclosure.

FIG. 3 depicts a high-level view of an image enhancement system for multi-channel color space dehazing, according to one or more embodiments of the disclosure.

FIG. 4 depicts a method of multi-channel multi-color space image enhancement, according to one or more embodiments of the disclosure.

While the embodiments of the disclosure are amenable to various modifications and alternative forms, specifics thereof have been shown by way of example in the drawings and will be described in detail. It should be understood, however, that the intention is not to limit the disclosure to the particular embodiments described. On the contrary, the intention is to cover all modifications, equivalents, and alternatives falling within the spirit and scope of the disclosure.

### DETAILED DESCRIPTION

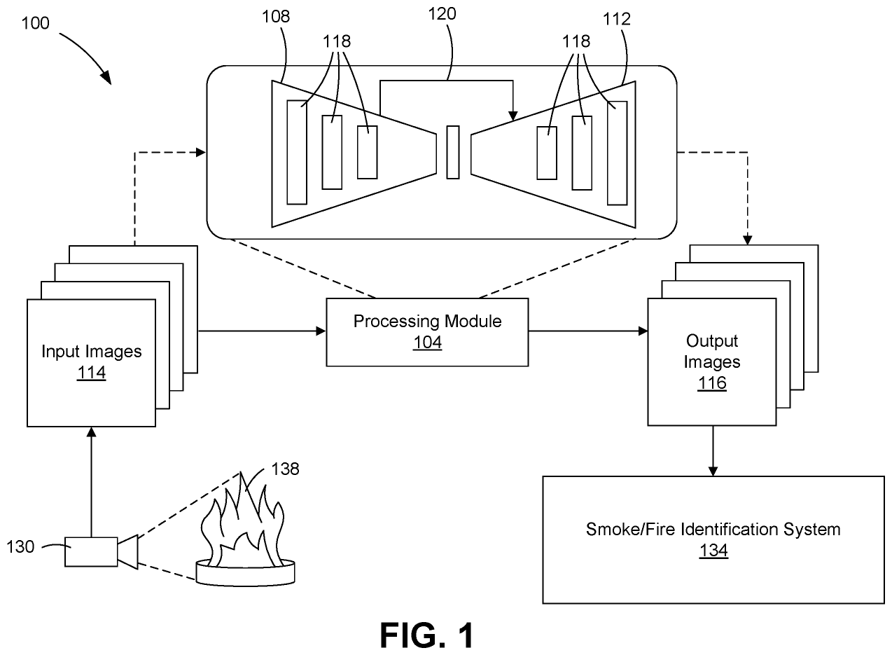

Referring to FIG. 1 a high-level view is depicted of an image enhancement system 100 for de-hazing images. Specifically, in one or more embodiments the system 100 includes a processing module 104 that is configured as a convolutional neural network (CNN) including an encoder portion 108 and decoder portion 112. In one or more embodiments the processing module is configured to receive one or more image inputs 114 and process the image inputs through (CNN) to remove haze from the one or more image inputs 114 and output a plurality of image outputs 116. For example, in various embodiments the encoder portion 108 and decoder portion 112 includes one or more layers 118, which can include convolutional layers, pooling layers, and/or fully connected layers. In such embodiments the convolutional layers apply filters to the image inputs 114 to extract meaningful features, while the pooling layers down sample the output of the convolutional layers. In various embodiments the fully connected layers then use the extracted features to make predictions about the input data to produce the output images 116.

In one or more embodiments the one or more layers 118 can include one or more skip connections 120. In such embodiments the one or more skip connections 120 allow information to flow directly from one layer 118 to another and bypassing one or more intermediate layers. In various embodiments, the one or more skip connection 120 is generally used to connect the output of an encoder layer to the input of a corresponding decoder layer. Described further below, in various embodiments the one or more skip connections 120 are configured as a layer-to-layer skip-connection. In such embodiments the layer-to-layer skip connection may be used to pass feature maps directly between individual convolutional layers. In such embodiments the CNN is configured to allow for transfer of a feature map from the encoder portion to the decoder portion at the individual layer level, rather than from a block-to-block level. This allows the decoder to have access to both low-level and high-level features of the input image, which improves the quality of the output.

In one or more embodiments the system 100 additionally includes a video device 130 that is configured to produce the one or more input images 114. In various embodiments, the video device 130 is configured for capturing a video of a scene comprising a series of input frames. In such embodiments the video can be received from the video capturing device 130, split the video into the one or more individual image inputs 114 and fed to the system 100 for frame-by-frame dehazing of the video feed. In such embodiments, the system can be configured to generate a dehazed video from the one or more output images 116, corresponding to the fames, by combining two or more dehazed image frames.

In various embodiments the image enhancement system 100 is a part of a smoke/fire detection system 134. For example, in various embodiments, the video device 130 could be directed at a scene (depicted in FIG. 1 as a flame 138) and is configured to generate video and the input images 114 for processing and object detection to identify the presence of smoke and/or fire. In such embodiments the camera-based fire detection system 134 is generally configured to generate an alarm output upon visual identification of heavy smoke or flame in a monitored space.

In various embodiments the image enhancement system can be configured as a first stage of the fire detection system. In such embodiments the system will first search for upcoming video frames. Once a video is found, the image enhancement system 100 is configured to input video frames and split them into individual frames, and then send each video frame to the processing module 104 to perform initial dehazing. In the last stage, the output (dehazed video frames) from the network will be sent to the smoke/fire detection system 134 for downstream tasks, such as fire detection, smoke detection, and the like.

In one or more embodiments, and described further below, the processing module 104 can be configured as a multi-channel multi-color space network. In such embodiments the processing module is configured to receive the input image and to convert it into a plurality of color space images each corresponding to a channel in a specific color space. For, example, in certain embodiments the input image could be an RGB image having three channels. The system could take the input image and convert it into three color space inputs each corresponding to one of the channels in the RGB, HSV, or other color space. In certain embodiments, the input image could be converted into a variety of different color space images based on different color spaces. Described further below, in various embodiments the module could then transmits the first and second data sets through a CNN such that an encoder portion of the CNN receives and processes each of the images, wherein the CNN outputs through the decoder portion a processed data set comprising a plurality of processed outputs corresponding to channels defining color spaces.

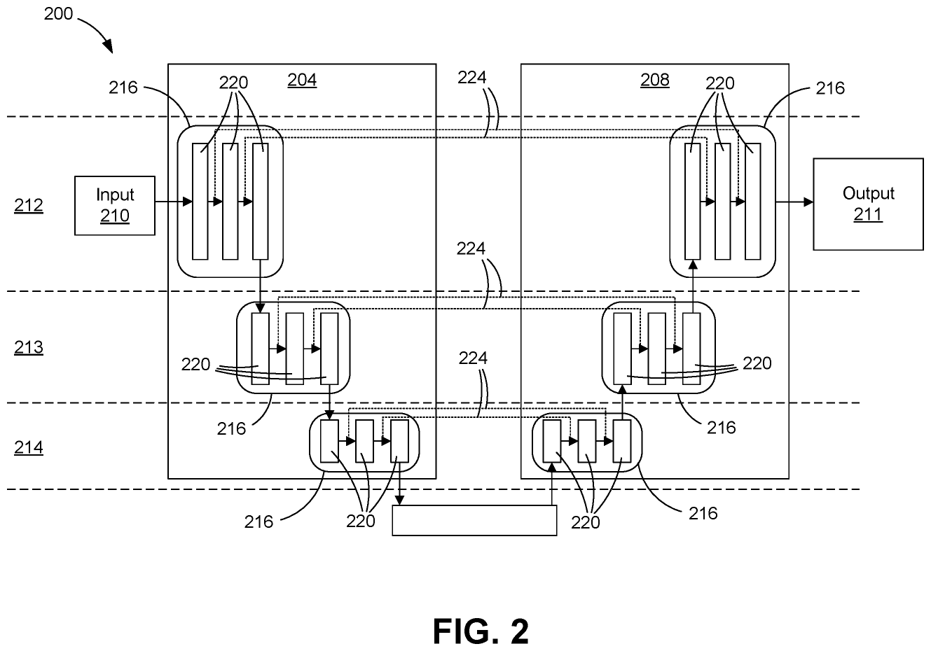

Referring to FIG. 2, a convolutional neural network (CNN) 200 with a U-net architecture and is depicted. Specifically, FIG. 2 depicts a CNN 200 having one or more layer-to-layer skip connections. In one or more embodiments the CNN 200 includes an encoder portion 204 and a decoder portion 208. In various embodiments the U-net architecture establishes a general path that input data 210 follows through the CNN 200, where the data 210 travels down through one or more levels 212-214 of the encoder portion 204, and back up through one more levels 212-214 of the decoder portion 208.

In one or more embodiments, when travelling downward from one level 212-214 to another in the encoder portion 204, data 210 is downsampled. Conversely, when data 210 travels up from one level to another in the decoder portion 208, the data 210 is upsampled. Data 210, such an image frame, enters the encoder portion 204 at a top-most level 212. In some embodiments, data 210 may be a channel from an image. At each level 212-214, the data 210 forms a convolutional block 216. Within each convolution block 216, the data 210 goes through one or more convolutions, each convolution generating a convolutional layer 220. In some embodiments, after the one or more convolutions, the data 210 may pass through a rectified linear unit. The convoluted data is then downsampled and passed to the next lower level 213 in the encoder portion 204. Upon reaching the lowest level 214, the data 210 works its way back up through the decoder portion 208 and is outputted as output data 211. Each level 212-214 of the decoder portion 208 corresponds to a level of the encoder portion 204. Accordingly, each level of the decoder portion 208 has a convolution block 216 which corresponds to a convolutional block of the encoder portion 204, forming a pair of convolutional blocks. Each pair of convolutional blocks has corresponding convolutional layers 220.

In some embodiments, skip-connections 224 may be used to pass feature maps between pairs of convolutional blocks. In some embodiments, layer to layer skip-connections 224 may be used to pass feature maps directly between corresponding convolutional layers 220 and bypassing one or more intermediate layers.

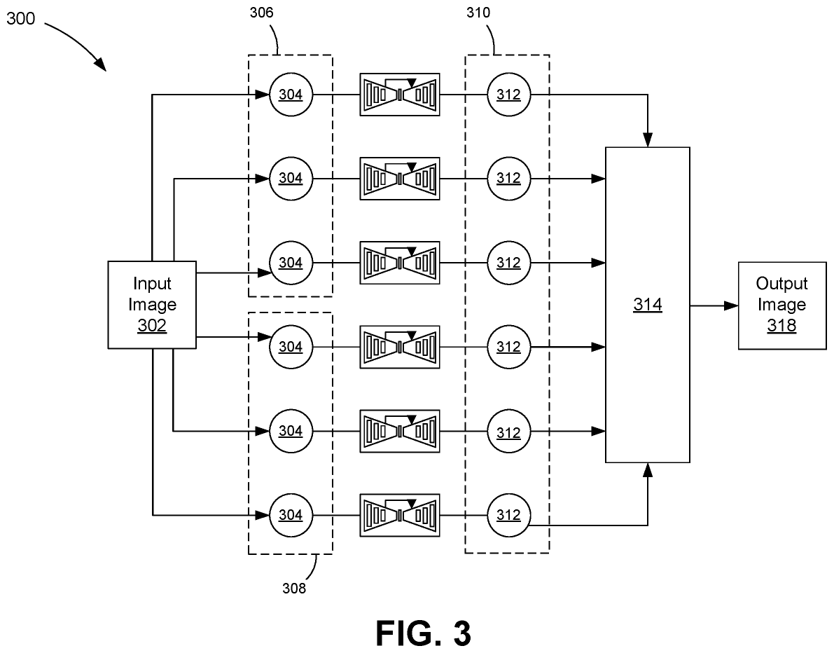

Referring additionally to FIG. 3, a high-level view of an image enhancement system 300 configured for multi-channel color space dehazing is depicted. The Applicants have observed that in encoder-decoder based dehazing methods the characteristics of haze are presented differently in different color spaces. For example, in various embodiments the system 300 is configured to receive an input image 302 and to convert it into a plurality of color space images 304 where each of the color space images 304 correspond to a channel in a specific color space. For, example, in certain embodiments the input image 302 could be an RGB image having three channels. The system 300 could take the input image 302 and convert it into three color space inputs 304 each corresponding to one of the channels in the RGB color space. In certain embodiments, the input image could be converted into a variety of different color space images based on different color spaces. Depicted in FIG. 3, the system 300 takes the input image 302 and generates a first data set by converting the input image 302 into a first plurality of images 306 each corresponding to a first plurality of color channels that define a first color space. In various embodiments the system 300 is configured to generate a second data set by converting the input image 302 into a second plurality of images 308 corresponding to a second plurality of color channels that define a second color space. In one or more embodiments the system 300 then transmits the first and second data sets through a CNN such that an encoder portion of the CNN receives and processes each of the first and second plurality of images, wherein the CNN outputs through the decoder portion a processed data set 310 comprising a plurality of processed outputs 312 corresponding to channels defining the first color space and the second color space. For example, the Applicants have discovered that, by processing images based on the different channels in the RGB and HSV color space, features that would not normally be seen can be extracted and learned by the proposed deep neural networks. In one or more embodiments, the CNN 300 could include one or more encoder-decoder pairs 304. For example, in various embodiments the encoder portion may be comprised of a plurality of encoder modules, and the decoder portion similarly including a corresponding number of decoder modules. In such embodiments the CNN 300 is capable of processing various types of data in parallel. In some embodiments, a CNN may process some data in serial and some data in parallel. In one or more embodiments, the plurality of processed outputs 312 are then recombined at an additional convolutional layer 314 to form an output image 318 from a concatenation the plurality of processed outputs 312.

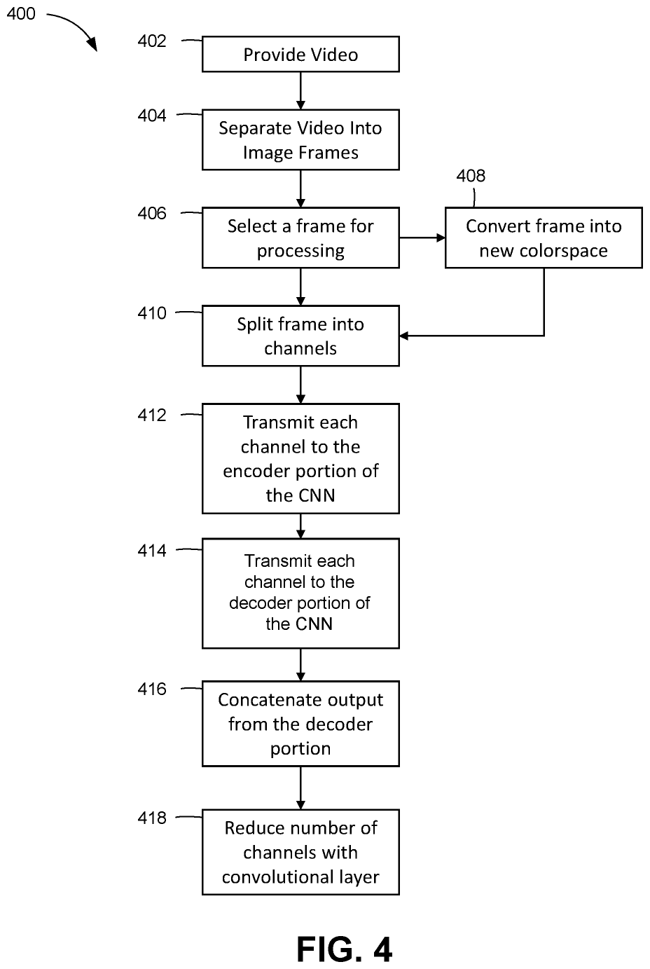

Referring to FIG. 4, a method 400 of multi-channel multi-color space image enhancement is depicted. In one or more embodiments, at operations 402-404, the method 400 includes providing a video data and generating a plurality of image frames from the provided video. In one or more embodiments, the method 400 includes, at operations 406-410, selecting a frame for processing and converting the frame into one or more color space images. For example, in various embodiments, the frame is converted into a specific color space, such as RGB, HSV, or the like, and then split into a plurality of channels each corresponding to the color space. In one or more embodiments, at operations 412-414, processing the plurality of channels through the encoder-decoder of a CNN to produce a plurality of processed outputs each corresponding to a color space channel. In various embodiments, at operations 416-18, the method 400 includes concatenating the plurality of processed outputs and reducing the number of channels with a convolutional layer to produce a final output. For example, in various embodiments, two or more color space channels could produce six or more processed outputs which are concatenated into a single image. In various embodiments the processed output can then be further processed by reducing the number of channels in the output image using a convolutional layer to a desired number. For example, reducing the number of channels from a six-channel output to a three channel RGB output.

One or more embodiments of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. An image enhancement system for de-hazing, the system comprising:
a convolutional neural network (CNN) having a U-net architecture comprising one or more levels, an encoder portion, a decoder portion, and a plurality of corresponding pairs of convolutional blocks at each level of the encoder portion and the decoder portion, each of the pairs of convolutional block having a first convolutional block in the encoder portion and a second convolutional block in the decoder portion, wherein each of the pair of convolutional blocks comprises a plurality of layers, the CNN being configured to provide a layer to layer skip-connection between each corresponding layer of each of the corresponding pairs of convolutional blocks, wherein each layer to layer skip-connection transfers a feature map from the encoder portion to the decoder portion;
a processor; and
a computer readable storage medium having program instructions embodied therewith, wherein the computer readable storage medium is not a transitory signal per se, the program instructions executable by the processor to cause the processor to:
receive an input image;
generate a first data set by converting the input image into a first plurality of images corresponding to a first plurality of color channels that define a first color space;
generate a second data set by converting the input image into a second plurality of images corresponding to a second plurality of color channels that define a second color space;
transmit the first and second data sets to the CNN such that the encoder portion of the CNN receives and processes each of the first and second plurality of images, wherein the CNN outputs through the decoder portion a processed data set comprising a plurality of processed outputs corresponding to channels defining the first color space and the second color space; and
generate a dehazed image by convoluting a concatenation the plurality of processed outputs.

2. The image enhancement system of claim 1, further comprising a video capturing device for capturing a video of a scene comprising a series of input frames, wherein the program instructions executable by the processor to cause the processor to:
receive the video from the video capturing device;
split the video into a plurality of individual image frames;
wherein the input image is an image frame in the plurality of individual image frames.

3. The system of claim 2, wherein the program instructions executable by the processor causes the processor to:
generate a dehazed video by combining two or more dehazed image frames.

4. The image enhancement system of claim 1, wherein the encoder and decoder portions process each of the plurality of channels in serial.

5. The image enhancement system of claim 1, wherein the encoder portion comprises one or more encoder modules and the decoder module comprises one or more encoder modules.

6. The image enhancement system of claim 5, wherein each of the one or more encoder modules is paired with a decoder module, each of the pairs of encoder and decoder modules being configured to process the plurality of channels in parallel.

7. The image enhancement system of claim 1, further comprising a camera-based fire detection system, wherein the dehazed, wherein the image enhancement system can be configured as a first stage of the fire detection system.

8. An image enhancement system for de-hazing video, the system comprising:
a convolutional neural network (CNN) having a U-net architecture comprising one or more levels, an encoder portion, a decoder portion, and a plurality of corresponding pairs of convolutional blocks at each level of the encoder portion and the decoder portion, each of the pairs of convolutional block having a first convolutional block in the encoder portion and a second convolutional block in the decoder portion, wherein each of the pair of convolutional blocks comprises a plurality of corresponding layers, the CNN being configured to provide a layer to layer skip-connection between each corresponding layer of each of the corresponding pairs of convolutional blocks, wherein each layer to layer skip-connection transfers a feature map from the encoder portion to the decoder portion;
a processor; and
a computer readable storage medium having program instructions embodied therewith, wherein the computer readable storage medium is not a transitory signal per se, the program instructions executable by the processor to cause the processor to:
receive an input image;
generate a first data set by converting the input image into a first plurality of images corresponding to a first plurality of color channels that define a first color space;
transmit the first data set to the CNN such that the encoder portion of the CNN receives and processes each of the first plurality of images, wherein the CNN outputs through the decoder portion a processed data set comprising a plurality of processed outputs corresponding to channels defining the first color space; and
generate a dehazed image by convoluting a concatenation the plurality of processed outputs.

9. The image enhancement system of claim 8, further comprising a video capturing device for capturing a video of a scene comprising a series of input frames, wherein the program instructions executable by the processor to cause the processor to:
receive the video from the video capturing device;
split the video into a plurality of individual image frames;
wherein the input image is an image frame in the plurality of individual image frames.

10. The image enhancement system of claim 9, wherein the program instructions executable by the processor causes the processor to:
generate a dehazed video by combining two or more dehazed image frames.

11. The system of claim 8 wherein the program instructions executable by the processor causes the processor to:
generate a second data set by converting the input image into a second plurality of images corresponding to a second plurality of color channels that define a second color space;
transmit the second data set to the CNN such that the encoder portion of the CNN receives and processes each of the second plurality of images and the decoder outputs into the plurality of processed outputs, wherein the plurality of processed outputs correspond to channels defining the first color space and the second color space.

12. The system of claim 9, wherein the program instructions executable by the processor causes the processor to:
generate a plurality of data sets by converting each of the plurality of individual images into a plurality of color spaces, each of the plurality of color spaces comprising a plurality of channels;
transmit the plurality of data sets to the CNN such that the encoder portion of the CNN receives and processes each of the plurality of channels of the plurality of data sets, wherein the CNN outputs through the decoder portion a plurality of processed data sets comprising a plurality of channels;
generate a dehazed image frame by convoluting a concatenation the plurality of channels of the first data set and the plurality of processed data sets.

13. The system of claim 12, wherein the program instructions executable by the processor causes the processor to:
generate a dehazed video by combining two or more dehazed image frames.

14. A fire detection system with image de-hazing, the system comprising:
a video capturing device for capturing a video of a scene comprising a series of input frames;
a convolutional neural network (CNN) having a U-net architecture comprising one or more levels, an encoder portion, a decoder portion, and a plurality of corresponding pairs of convolutional blocks at each level of the encoder portion and the decoder portion, each of the pairs of convolutional block having a first convolutional block in the encoder portion and a second convolutional block in the decoder portion, and a skip connection there between a processor; and
a computer readable storage medium having program instructions embodied therewith, wherein the computer readable storage medium is not a transitory signal per se, the program instructions executable by the processor to cause the processor to:
receive the video from the video capturing device;
split the input frames from the video into a plurality of individual images;
generate a first data set by converting each of the plurality of individual images corresponding to a first color space comprising a plurality of channels;
generate a second data set by converting each of the plurality of individual images corresponding to a second color space comprising a plurality of channels;
transmit the first and second data sets to the CNN such that the encoder portion of the CNN receives and processes each of the plurality of channels of the first data set and each of the plurality of channels of the second data set, wherein the CNN outputs through the decoder portion a first processed data set comprising a plurality of channels and a second processed data set comprising a plurality of channels, the first processed data set corresponding to the color space of the first data set and the second processed data set corresponding to the color space second data set; and
generate a dehazed image frame by convoluting a concatenation of the plurality of channels of the first and second processed data sets.

15. The system of claim 14, wherein each of the pairs of convolutional blocks comprises a plurality of corresponding layers, the CNN being configured to provide a layer-to-layer skip-connection between each corresponding layer of each of the corresponding pairs of convolutional blocks.

16. The system of claim 15, wherein each layer-to-layer skip-connection is configured to transfer a feature map from the encoder portion to the decoder portion.

17. The system of claim 14, wherein the encoder and decoder portions process each of the plurality of channels in serial.

18. The system of claim 14, wherein the encoder portion comprises one or more encoder modules and the decoder module comprises one or more encoder modules.

19. The system of claim 18, wherein each of the one or more encoder modules is paired with a decoder module, each of the pairs of encoder and decoder modules being configured to process the plurality of channels in parallel.

20. The system of claim 14, wherein the dehazed image frame is a first stage input of the fire detection system.
